(19) United States
(12) Patent Application Publication
(10) Pub. No.: US 2008/0209329 A1
(43) Pub. Date: Aug. 28, 2008

(54) SYSTEMS AND METHODS FOR SHARING DATA

(76) Inventors: Robert DeFranco, Glastonbury, CT (US); Stephen Tyler Rollin, Marlborough, MA (US)

Correspondence Address: GOODWIN PROCTER LLP;PATENT ADMINISTRATOR, EXCHANGE PLACE, BOSTON, MA, 02109-2881, US

(21) Appl. No.: 12/033,523

(22) Filed: Feb. 19, 2008

Related U.S. Application Data
(60) Provisional application No. 60/902,389, filed on Feb. 21, 2007.
(60) Provisional application No. 60/920,103, filed on Mar. 26, 2007.
(60) Provisional application No. 60/949,125, filed on Jul. 11, 2007.

(51) Int. Cl. G06F 3/048; G06F 15/16

(52) U.S. Cl. 715/733; 709/206

(57) ABSTRACT

To share stored data with a recipient, a communication identifying the recipient may be received, the stored data to be shared with the recipient may be automatically determined from the received communication, and presentation of a human-readable card, which includes both textual and graphical information, may be caused. The human-readable card may be caused to be presented in substantially its entirety on a display of a mobile handheld computing device employed by the recipient.

### CROSS-REFERENCE TO RELATED APPLICATIONS

This application claims priority to and the benefit of, and incorporates herein by reference in its entirety, U.S. Provisional Patent Application No. 60/902,389, which was filed on Feb. 21, 2007, U.S. Provisional Patent Application No. 60/920,103, which was filed on Mar. 26, 2007, and U.S. Provisional Patent Application No. 60/949,125, which was filed on Jul. 11, 2007.

### TECHNICAL FIELD

The invention generally relates to systems and methods for sharing data. More particularly, the invention relates, in various embodiments, to systems and methods for sharing data amongst users of mobile handheld computing devices.

### BACKGROUND

The market for mobile communication devices continues to expand. As the user base of mobile communication devices continues to grow, so do the number and types of services that such devices offer. No longer are mobile communication devices limited to providing just voice communication services. Rather, mobile handheld computing devices having data communication functions and information processing functions have recently come into use. For example, mobile handheld computing devices, such as cell phones and blackberries, may be used to exchange text messages, to browse the Internet, and/or to exchange e-mails.

The manners in which users of mobile handheld computing devices currently share data amongst themselves are, however, typically limited, inconvenient, and/or inefficient. For example, known mobile messaging systems that employ the Short Message Service (“SMS”) communications protocol are typically limited to sharing only text-messages with other mobile devices. On the other hand, employing the Multimedia Messaging Service (“MMS”) communications protocol on a mobile handheld computing device may be resource intensive, and is often cumbersome in use for many users.

### SUMMARY OF THE INVENTION

In one embodiment, the present invention provides a communication system that enables the development and communication of data between users of devices. The system is, in accordance with one embodiment of the invention, particularly suitable for use by mobile handheld computing devices, such as, for example, mobile telephones, smart phones, and wireless personal digital assistants. The system may, however, also be used, accessed, and/or managed by or through other computing devices, such as, for example, laptop computers, desktop computers, video terminals, game machines, and internet kiosks.

In some embodiments, the data communicated between the users is provided in the form of an electronic, human-readable “card” (e.g., an electronic business card, baseball card, index card, etc.), which may, for example, contain data, graphics, information concerning its physical layout, metadata about the data, and script or program code to implement features of the card. The cards may be rendered, edited/modified, collected and aggregated, stored, searched, navigated, and communicated to others. In one embodiment, the cards are stored at a service provider's server and each card is configured for presentation in substantially its entirety on a display of a mobile handheld computing device.

In one embodiment, a user of an originating device shares a card containing one or more of the above features with a recipient by transmitting to the service provider a text-based communication that contains in its body no more than an identifier for the recipient. The text-based communication may be, for example, an SMS message, an e-mail message, or an instant message. The service provider may then, in response to the text-based communication, share the card with the recipient. In another embodiment, the user shares the card with the recipient by selecting a graphic on an internet web page. The selection of the graphic is communicated to the service provider, which may then share the card with the recipient. Accordingly, in one example, a business card containing not only contact information (typically in text-form), but also graphics and other appealing visual effects, may be readily and efficiently shared amongst users of mobile handheld computing devices.

As described, the “originating” mobile handheld computing device need not contain a dedicated and specialized software application (which could be complex and resource-heavy when implemented on a device having limited resources) to initiate the sharing of the card with a recipient. Likewise, the “receiving” mobile handheld computing device need not contain a dedicated and specialized software application to view the card. For example, a link to the card may be sent to the recipient by the service provider in a text based message, such as in an SMS, e-mail, or instant message. In one such exemplary case, the recipient need only have installed on his mobile handheld computing device a text-based messaging program to receive and read the service provider's message, and a mobile internet application to access the link provided by the service provider and view the card. Alternatively, in other embodiments, either or both the originating mobile handheld computing device and the recipient mobile handheld computing device include a card-based application (i.e., a specific application that allows a user of the device to interact with the electronic, human-readable cards described herein). The card-based application may be, for example, downloadable over a network using any transport protocol available.

In various embodiments, the communication system of the present invention protects the user's privacy by maintaining portions of his information stored at the service provider confidential. Moreover, the electronic, human-readable cards described herein may be communicated in different manners, and/or in different formats, appropriate for different devices. For example, different communication protocols and different data formats for the cards may be used depending on the capabilities of the particular receiving device. More specifically, cards may be shared using links embedded in an SMS message, an email message, and/or an instant message, as web downloads (e.g., ftp, http/https), or using any other transport mechanism suitable for the receiving device.

In general, in one aspect, the invention features a method for sharing stored data. In accordance with the method, a communication identifying a recipient may be received from a first computing device, stored data to be shared with the recipient may be automatically determined from the received communication, and presentation of a human-readable card, which includes both textual and graphical information, may be caused. The human-readable card may be caused to be presented in substantially its entirety on a display of a mobile handheld computing device employed by the recipient, such as a mobile phone.

In general, in another aspect, the invention features a system for sharing stored data. The system may include a receiver for receiving, from a first computing device, a communication identifying a recipient, a determination module for automatically determining, from the received communication, stored data to be shared with the recipient, and a presentation module for causing presentation of a human-readable card that includes both textual and graphical information. The presentation module may be configured to cause presentation of the human-readable card in substantially its entirety on a display of a mobile handheld computing device employed by the recipient, such as a mobile phone.

In various embodiments of the invention, the communication received from the first computing device is a text-based message, such as, for example, an SMS message, an e-mail message, or an instant message. The content of the communication may, for example, consist solely of text. Alternatively, in another embodiment, the communication originates from the selection, by a user of the first computing device, of a graphic on an Internet web page. The communication may be received over a network from a mobile handheld computing device or from a desktop computing device.

In some embodiments, the content of the communication received from the first computing device includes or consists solely of a first identification for a destination of the communication, a second identification for a user of the first computing device, and a third identification for the recipient. Alternatively, in a different embodiment, the content of the communication received from the first computing device includes or consists solely of a first identification for a destination of the communication, a second identification for a user of the first computing device, a third identification for the recipient, and an accessibility profile specifying the stored data to be shared with the recipient. The accessibility profile may specify that stored data divulging an identity of the user of the first computing device is not to be shared with the recipient.

In various embodiments, the communication received from the first computing device includes information concerning the display of the mobile handheld computing device employed by the recipient, and automatically determining the stored data to be shared with the recipient includes creating a link to a stored version of a human-readable card that is appropriate for presentation on the display of the recipient's mobile handheld computing device. The stored data may include data that is personal to a user of the first computing device, such as, for example, contact information for the user, biographic information of the user, information concerning interests of the user, information concerning activities related to the user, health information for the user, account information for the user, and business information for the user. Alternatively, the stored data may be advertising information. In various embodiments, the human-readable card is a live card configured to be updated with new data over time. For example, at least a portion of the human-readable card may be configured to represent a Really Simple Syndication (“RSS”) feed to the recipient.

Optionally, a message may be transmitted to the recipient prior to causing presentation of the human-readable card to the recipient. The transmitted message may be, for example, a text-based message, such as an SMS message, an e-mail message, or an instant message. The transmitted message may include, for example, a link to the human-readable card that permits the recipient to view the card via a mobile browser.

In general, in still another aspect, the invention features a method for creating a human-readable card for dissemination over a computer network. In accordance with the method, a picture and textual information may be received at a server and be automatically processed, at the server, into at least one human-readable card. The human readable card may be configured for dissemination over a computer network and also for presentation in substantially its entirety on a display of a mobile handheld computing device.

In general, in yet another aspect, the invention features a system for creating a human-readable card for dissemination over a computer network. The system may include a receiver for receiving a picture and textual information, and a processing module for automatically processing the picture and the textual information into at least one human-readable card. Again, the human readable card may be configured for dissemination over a computer network and also for presentation in substantially its entirety on a display of a mobile handheld computing device.

In various embodiments, the picture and textual information are automatically processed into a plurality of human-readable cards, each one of which is configured for presentation in substantially its entirety on the display of a different mobile handheld computing device. The human-readable card(s) may be stored in storage, for example at the server.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram of an illustrative embodiment of a system for sharing data in accordance with the invention;

FIG. 2 is a conceptual illustration of an embodiment of an electronic, human-readable card in accordance with the invention;

FIG. 3 is flow diagram of an illustrative embodiment of a method for creating a human-readable card in accordance with the invention;

FIG. 4 is a flow diagram of an illustrative embodiment of a method for sharing data in accordance with the invention; and

FIGS. 5-8 depict several non-limiting examples of methods for sharing data in accordance with embodiments of the invention.

### DESCRIPTION

In various embodiments, the present invention pertains to systems and methods for sharing data, such as an electronic, human-readable card, over a computer network. In broad overview, in accordance with one embodiment of the invention, a first computing device, for example a server at a service provider, receives a communication from a second computing device. The communication may identify a recipient with whom a user desires to share data. The communication may be, for example, a text-based message received from a mobile handheld computing device. Alternatively, the communication may be a command received from a third-party server following the selection by the user of a graphic displayed on an Internet web page hosted by the third-party server. In one embodiment, the service provider's server automatically determines, from the received communication, stored data to be shared with the recipient. The service provider's server may then create a link to the stored data and transmit to the recipient a text based message having the link embedded therein. Once the recipient accesses the link, the service provider's server may cause presentation of the stored data to the recipient. Alternatively, the service provider's server may retrieve the stored data and then directly transmit the stored data to the recipient. In either case, the stored data may be presented to the recipient in the form of, for example, an electronic, human-readable card that includes both textual and graphic information.

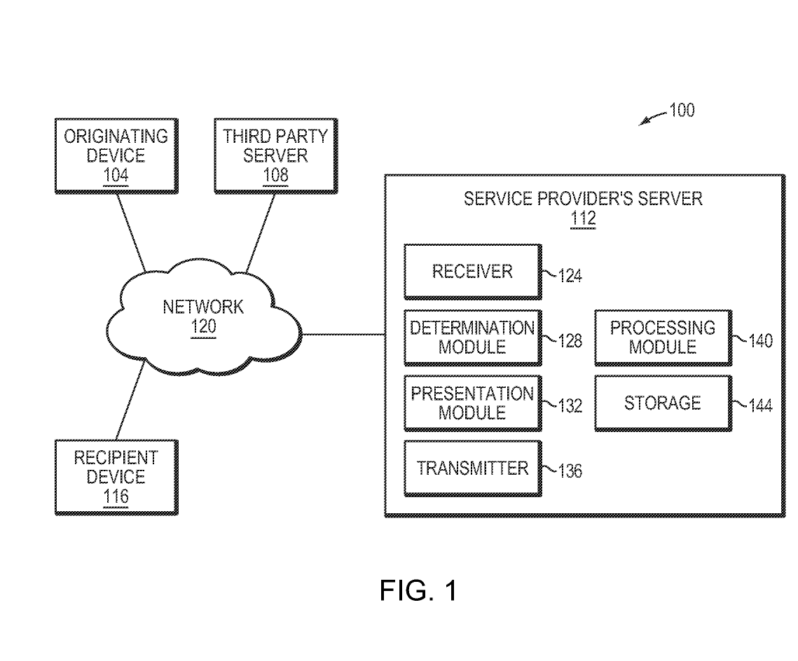

FIG. 1 depicts an exemplary system 100 for sharing data in accordance with embodiments of the invention. As illustrated, the system 100 may optionally include an originating device 104, a third party server 108, a service provider's server 112, a recipient device 116, and a network 120. Additional networks may also be present to facilitate the communication between the devices 104, 116 and servers 108, 112 illustrated in FIG. 1. As illustrated, the service provider's server 112 may include a receiver 124, a determination module 128, a presentation module 132, a transmitter 136, a processing module 140, and storage (e.g., memory) 144.

The network 120 may be, for example, a local-area network (LAN), a metropolitan area network (MAN), or a wide area network (WAN). The various devices 104, 116 and servers 108, 112 illustrated in FIG. 1 may be connected to the network 120 through a variety of connections including, but not limited to, standard telephone lines, LAN or WAN links (e.g., T1, T3, 56 kb, X.25), broadband connections (e.g., ISDN, Frame Relay, ATM), or wireless connections. The connections, moreover, may be established using a variety of communication protocols (e.g., SMS, MMS, HTTP, TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g, and direct asynchronous connections).

Each of the originating device 104 and recipient device 116 may be any type of personal computer, Windows-based terminal, network computer, wireless device, information appliance, RISC Power PC, X-device, workstation, mini computer, main frame computer, personal digital assistant, set top box, handheld device, or other computing device that is capable of both presenting information/data to, and receiving commands from, a user of the device 104, 1 16. In some embodiments of the invention, both the originating device 104 and recipient device 116 are mobile handheld computing devices, such as, for example, mobile telephones, smart phones, or wireless personal digital assistants. Each of the originating device 104 and recipient device 116 may have one or more unique identifiers, which may, for example, directly or indirectly reference a phone number of the wireless communication device 104, 116.

The originating device 104 and recipient device 116 may also each include, for example, a visual display (e.g., a relatively small-sized screen on a mobile handheld computing device, or a larger monitor on a desktop computer), a data entry device (e.g., keys on a mobile handheld computing device, or a keyboard and mouse on a desktop computer), persistent and/or volatile storage (e.g., memory), and a processor. In one embodiment, the originating and recipient devices 104, 116 each include the necessary hardware and software for sending and/or receiving text-based messages, such as, for example, SMS messages, e-mails, and instant messages. For example, the originating and recipient devices 104, 116 may each include an SMS client application or a card-based client application for sending and/or receiving SMS messages. Moreover, the originating and recipient devices 104, 116 may include a web browser (e.g., a proprietary mobile web browser on a mobile handheld computing device, or the INTERNET EXPLORER program developed by Microsoft Corporation of Redmond, Wash., on a desktop device) to connect to the World Wide Web.

In one embodiment, a user of the originating device 104 is a subscriber to the services offered by the service provider's server 112 (i.e., is enrolled as a registered member by the service provider). A user of the recipient device 116 may or may not be registered with the service provider. Registration forms may be sent to non-members when they interact with the service provider's server 1 12.

For its part, the third-party server 108 may be any computing device capable of receiving information, data, or commands from a device or another server over the network 120, and of delivering information, data, or commands to a device or another server over the network 120. For example, as described further below, the third party server 108 may be a web-server that presents an Internet web page to the originating device 104 and that transmits commands to the service provider's server 112 upon a user of the originating device 104 selecting a graphic from that Internet web page.

Similarly, the service provider's server 112 may be any computing device capable of receiving information, data, or commands from a device or another server over the network 120, and of delivering information, data, or commands to a device or another server over the network 120. For example, as described further below, the service provider's server 112 may receive a communication from either the originating device 104, the third party server 108, or both, and in response thereto transmit a message to the recipient device 116.

The determination module 128, presentation module 132, and processing module 140 of the service provider's server 112 may each be implemented as any software program and/or hardware device, for example an application specific integrated circuit (ASIC) or a field programmable gate array (FPGA), that is capable of providing the functionality described below. It will be understood by one having ordinary skill in the art that the illustrated modules 128, 132, and 140 and organization thereof are conceptual, rather than explicit, requirements. For example, any two or more modules (e.g., the determination module 128 and processing module 140) may be combined into a single module, such that the functions performed by the two or more modules, as described below, are in fact performed by the single module. In addition, it should be understood that any single one of the modules 128, 132, and 140 may be implemented as multiple modules, such that the functions performed by any single one of the modules 128, 132, and 140, as described below, are in fact performed by the multiple modules.

For their part, the receiver 124 and transmitter 136 of the service provider's server 112 may each be any hardware device, or software module with a hardware interface, that is capable of receiving and transmitting, respectively, communications. Those communications may include requests, responses, commands, information, and data, such as, for example, inter-processor communications and networked communications. In another embodiment, the functions performed by the receiver 124 and transmitter 136 are performed by a single transceiver (not shown).

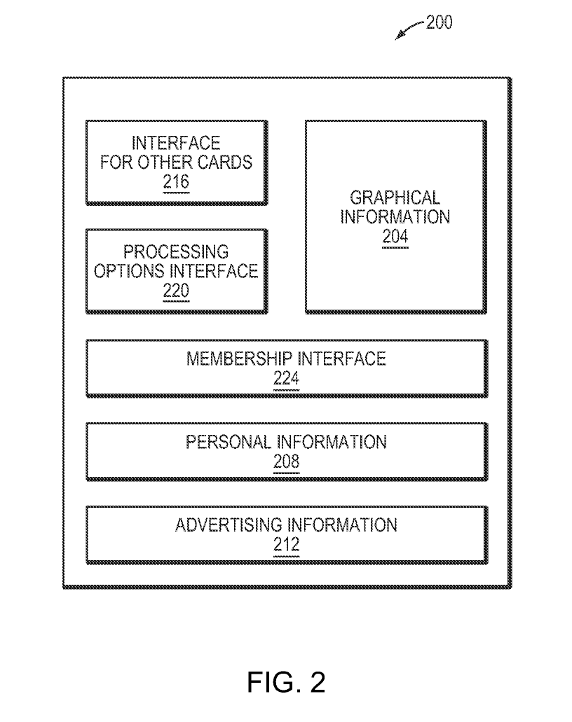

The storage 144 for the service provider's server 112 may be any hardware device, or software module with a hardware interface, that is capable of storing data in accordance with embodiments of the invention, such as the human-readable cards 200 (see FIG. 2) generated by the processing module 140 as described below. The storage 144 may be, for example, persistent memory implemented on the service provider's server 112. Alternatively, the storage 144 could be implemented as a separate database (or group of databases) that stores and manages collections of data and that is in communication with the service provider's server 112. In one such embodiment, the storage 144 database is any computing device capable of receiving commands/queries from and delivering information/data to the service provider's server 112. For example, the storage 144 database may communicate using SQL or another language. The storage 144 of the service provider's server 112 may store, for example, subscribers' identities, data, and themes for user interfaces and cards 200 (see FIG. 2), which themes may include color schemes, images, icons, and fonts.

In one embodiment, the service provider's server 112 provides a networked service that is addressable over a mobile network 120 (e.g., an SMS network), stores subscribers' data, and provides sharing of subscriber data. For example, when a user of the originating device 104 requests to share his data with another user (e.g., a user of the recipient device 116), the service provider's server 112 may send an indirect reference to the originating user's data stored on the service provider's server 112 to the recipient device 116. When a user of the recipient device 116 views the reference to the originating user's data, the data may be rendered for immediate viewing on the recipient device 116 utilizing the originating user's reference properties, such as the selected identity, theme, accessibility profile, and digital rights of the selected data. Moreover, after receipt of the originating user's data, the originating user may maintain control of any and all information that continues to reside at the service provider's server 112.

In some embodiments, the service provider's server 112 is addressable by such protocols as SMS using, for example, a modem or SMS Aggregator. The service provider's server 112 may appear to the originating user's device 104 to be simply another wireless communication device. In one embodiment, the service provider's server 112 maintains the originating user's information securely online.

In addition, the service provider's server 112 may provide each user with a directory service that they may use to address communications to recipients. By default, for example, the directory service may be the 10-digit US telephone numbering system. The user may, however, configure a default directory service and one or more secondary directory services. The secondary directory services may store naming schemes that do not conform to the addressing scheme used within the system 100 (e.g., the 10-digit telephone number addressing scheme). Such naming schemes may include, for example, private shortcuts to recipients (e.g., nicknames or abbreviations) and be used for referencing the recipients. In one embodiment, when a communication is received at the service provider's server 112, the naming scheme used to reference the recipient device 116 is verified by the directory service.

It will be understood by those skilled in the art that FIG. 1 is a simplified illustration of the system 100 and that it is depicted as such to facilitate the explanation of the present invention's embodiments. Moreover, the system 100 may be modified in a variety of manners without departing from the spirit and scope of the invention. For example, there may be multiple originating devices 104, multiple third party servers 108, multiple recipient devices 116, and multiple networks 120 in the system 100. Moreover, the functionality of the service provider's server 112 may in fact be implemented by many servers, rather than by just the single server 112 depicted in FIG. 1. As such, the depiction of the system 100 in FIG. 1 is non-limiting.

With reference now to FIG. 2, an exemplary electronic, human-readable card 200 is depicted. Generally speaking, the format for the card 200 provides an easy to use visual layout template that non-technical users may complete, as described below, with combinations of, for example, graphics, style, and textual information for sharing. In addition, digital rights may be associated with the card 200. As illustrated in FIG. 2, the electronic, human-readable card 200 may include one or more of graphical information 204, personal information 208, advertising information 212, an interface for other cards 216, a processing options interface 220, and a membership interface 224. Each electronic, human-readable card 200 may include different sections and different information in its different sections, depending on the type of card 200 and template therefor.

For example, where the card 200 is a business card, the graphical information 204 may include a company logo. Alternatively, the card may be for one's pet and the graphical information 204 may therefore include a photograph of the pet. In still another example, the card may be intended for use in a social network and the graphical information 204 may therefore include a picture of the card's creator/owner. Such a picture may also be considered personal information 208, as described below. In essence, any type of graphical information 204 appropriate for the types of cards described below may be included in the card 200.

In one embodiment, at least some of the graphical information 204 is embedded with content and/or content tags not viewable by the owner/creator or recipient of the card 200. The embedded content may, however, be accessible to and executable by the content provider's server 112. The embedded content may include, for example, links to other content or instructions relating to the refreshing of information related to the card 200. The content may be embedded into the graphical information 204 by, for example, steganography or another similar technique. In one embodiment, this facilitates the exchange of encrypted and/or hidden information not viewable as part of the card 200.

The personal information 208 may include, for example, personal data associated with the creator/owner of the card 200. As mentioned, the personal information 208 may be a photograph of the card's creator/owner. Alternatively, the personal information 208 may be textual information and may be any data collected by the card's owner/creator that is relevant to him or her in business or personal settings. For example, the personal information 208 may include, without limitation, contact lists or contact books (e.g., collections of information typically included in a business card, biographic information, etc.), information concerning interests or activities of the card's owner/creator (e.g., interest lists, wish lists, health information, account information, activity statistics, information typically included in a sports card, information included about a performance, show, or event, membership card information, identification numbers and information, etc.), and business information (e.g., financial account information, business data, etc.).

In some embodiments, a card's owner/creator may select to associate advertising information 212 with his human-readable card 200. In one embodiment, when creating the human-readable card 200, the creator is presented with a preview of his card 200 with an advertisement inserted therein. The creator may then change the advertisement and select a new advertiser or advertisement for inclusion in the card 200. This dynamic allows for personalization and choice in the advertising process. It also allows an advertiser to advertise during the card creation process and on delivery of the card 200. The card's creator may also choose to designate a certain advertiser as his sponsor, which may then remain in a sponsor library base at the service provider's server 112 (e.g., in storage 144). In such a fashion, any or all cards 200 shared by the creator with the recipient device 116, according to the exemplary processes described below, may include advertisements and/or messages from that sponsor as part of the advertising information 212. This allows the card's owner/creator and advertiser to have a connected and permanent relationship.

In one embodiment, the interface for other cards 216 is a section of the card 200 presenting other cards belonging to the owner/creator of the card 200 in question. For example, the interface 216 may present thumbnails of other cards or a descriptive list of other cards. Links to those other cards may be separately provided in the interface 216, or embedded in the thumbnails and/or in the descriptive identifiers in the descriptive list.

The processing options interface 220 may present different processing options to a recipient of the card 200. Exemplary processing options includes options for saving the card 200, rejecting/discarding the card 200, and forwarding the card 200 to another user. Any suitable mechanism for allowing a user to select the options may be employed, including, but not limited to, icons, push-buttons, and radio-buttons. In one embodiment, if the recipient of the card 200 is registered with the service provider, electing to save the card 200 results in the card 200 being stored in the recipient's account in storage 144 of the service provider's server 112.

Because a card 200 may be centrally stored in the storage 144 of the service provider's server 112 and shared with a recipient device 116 by providing to the recipient device 116 a link to the card 200, the card's content may be controlled and updated with new data over time (e.g., periodically) by its owner/creator. In other words, the card 200 may be a “live” card 200. Thus, another processing option that may be presented in the processing options interface 220 is an option to refresh the card 200. By choosing to refresh the card 200, the recipient will be presented with the most up-to-date information for the card 200 that is stored in the storage 144 of the service provider's server 112. Alternatively, if, as described herein, the recipient was originally sent a text-based message having a link to the card 200 embedded therein, the recipient may choose to refresh the card by again accessing the embedded link. In one embodiment, when the recipient elects to refresh the card 200, a notification is first sent by the service provider's server 112 to the originating device 104. The user of the originating device 104 may then approve or disapprove the refresh of the card 200.

In still another embodiment, the card 200 includes a membership interface 224, whose purpose may be to help the service provider expand its user base. For example, the membership interface 224 may include links directing the recipient to a registration page, to terms of service, or to a log-in page.

The card 200 may include any number of other sections and include any other type of data. For example, an owner of a third party web-server 108 that hosts a web-page may desire to make information from that web-page sharable in the form of a human-readable card 200. For example, the owner may desire to make an RSS feed from the web-page sharable in the form of a card 200. In one such embodiment, the owner creates and stores in the storage 144 of the service provider's server 112 a card 200 in which the headlines from the RSS feed are presented as static links in the card 200. The card 200 may, however, be a live card 200, as described above. In such a fashion, the static links representing headlines of the RSS feeds in the card 200 may be periodically updated. When the card 200 is shared with a recipient, the recipient will be presented with static links representing an RSS feed at a given point in time. To access and review an article behind the RSS feed, the recipient may click on the link. Again, the recipient may choose to refresh the card 200 at any point in time to see if new feeds (represented to recipient in the form of static links in the card 200) have been added. Accordingly, in accordance with embodiments of the invention, content from an application, such as, for example, an RSS feed reader, may be shared with, and viewed in card 200 form by, a user of a recipient device 116 even though the application in question is not installed on the recipient device 116.

In one embodiment, the owner of the web-page hosted by the third party server 108 may choose to make content from his web-page (e.g., the RSS feed) sharable by a user of an originating device 104 who is browsing that web page by embedding in the web page a graphic or widget. As further described below, upon selection of that graphic or widget, the user of the originating device 104 may cause certain content from the web page to be shared with a recipient device 116.

In one particular embodiment of the invention, the electronic, human-readable card 200 is configured for presentation in substantially its entirety on a display of a mobile handheld computing device. In other words, the card 200 may be optimized and appropriately sized so that a user of the mobile handheld computing device is able to legibly view substantially the entire card 200 at once and need not scroll through the card 200 in order to view its content. In some embodiments, this involves placing an upper limit on the amount of content that may be included in the card 200. Different versions of the cards 200 for different displays of recipient devices 116 (e.g., displays having different sizes and/or different presentation capabilities) may be optimized and sized differently. For example, the width and height of the card 200 may be sized differently amongst versions of the card 200 for different displays of recipient devices 116, and a different layout for the card 200 (e.g., landscape or portrait) may be chosen for different displays of recipient devices 116. As another example, different recipient devices 116 may have different browsers that employ different presentation languages (e.g., HTML, XHTML, WAP, etc.) and, as such, different markup languages may be chosen for different versions of the card 200. In yet another example, different image formats (e.g., GIF, PNG, JPEG, WBMP, etc.) may be chosen for different versions of the card 200. In addition, the total image size for the card 200 may be controlled and optimized so as not to exceed the memory capabilities of the recipient mobile handheld computing device 11 6. Again, this image size may be different for different recipient devices 116.

The generalized format for the card 200 described above may be adaptable into many different template forms so that users may create new and different categories of content. Nevertheless, the format for the card 200 may still have a substantially constant structure such that the card 200 is capable of being rendered in substantially its entirety on a display of a mobile handheld computing device, such as a mobile phone.

For example, a card 200 may have both a front face and a back face that are independently presentable in substantially their entirety on the display of a mobile handheld computing device. Each face of the card 200 may have a different visual layout template, content, and digital rights. A visual layout template may include a boundary, background, fonts, images, and one or more of the data sections described above, or other data sections. A data section may include one or more data fields which may hold various forms of data, such as, for example, text, hyperlinks, images, audio, video, and account information for an online service. The data fields may be pre-populated by the service provider's server 112, and may be configured for editing by owners/creators of the cards 200.

The cards 200 may be aggregated into an electronic collection, such as an electronic deck or pack. The aggregate collection of cards 200 may be shared using the same mechanisms as described herein for individual cards 200. In addition, a card 200 may be packaged for delivery. For example, the card 200 may be placed into a virtual envelope, such as, for example, a plain letter envelope that does not hint at the content on the inside, a postcard which shows the content immediately, a brown paper bag which may be used to indicate privacy, or even a gift box which indicates that a gift has been received.

A user may allow the cards 200 he has shared to have their data fields edited by recipients. In another embodiment, if the user does not permit editing of his cards 200 by recipients, a recipient may create an overlay of the card 200 and perform edits on the overlay. For example, a recipient may make notes on a business card when it is received so that he knows when and where the card was received.

Many different types of electronic, human-readable cards 200 may be created and used to share many different types of information. The following provide several examples.

An electronic, human-readable social network card 200, for example a Myspace card, may be a template that allows a user to include pertinent information from his Myspace page to share with others. The user may input his username, demographic, image, and other information to the mobile Myspace card and then share that card with a recipient so that the recipient may connect with him.

An electronic, human-readable contact (business or personal) card 200 may allow a user to add his business or personal information, logos, style, and/or image to a template that may easily be shared with and rendered on a recipient device 116, such as a mobile handheld computing device. Allowing multiple types of information to be included in the card gives the user the ability to emulate a standard business card or create a new digital representation of his business or personal information. In addition, a user may share his business or personal cards with a recipient so that the recipient need not type pertinent contact or other information from the card into the recipient device 116. Rather, the recipient may simply refer to the card in the future.

An electronic, human-readable real estate card 200 may be a template to easily share a real estate listing. The card may be created from a listing service or manually entered in the template. A recipient of the card may interact with the card (for example with its processing options interface 220) to sign up to receive automatic notifications of listings in the future (for example in the form of a human-readable card 200 or other form).

An electronic, human-readable virtual pet card 200, for example a Webkinz card, may be a template that allows a user who has purchased a Webkinz toy to input his username, his pet's name, and an image for sharing with recipients.

An electronic, human-readable media card 200, for example an ESPN card, may allow media publishers or any publisher to push information into a template so that the card may be easily shared with and accessed from a mobile handheld computing device 116.

An electronic, human-readable membership or social security card 200 may be a template that allows a user to add pertinent account information to the card, such as an account number, so that he may later access it from a mobile handheld computing device. This may, for example, eliminate the need for the user to carry a physical copy of the membership or social security card in his wallet. The electronic, human-readable card 200 may be password protected so that only its creator/owner may access and/or share it. The card may also include a barcode of the account number so that the user may interact with existing barcode scanner systems without having a physical copy of the card on hand.

An electronic, human-readable gift card 200 may be a template that a retailer, for example Apple iTunes, offers for sale to a user of the system 100 to purchase and send to himself or to a recipient as a gift for redemption.

An electronic, human-readable corporate business information card 200, for example a restaurant card, may be a template that restaurants use to add their pertinent information, including contact information, hours of operation, and a menu hyperlink, and then make available to users of the system 100.

An electronic, human-readable photo card 200 may be a template that allows users to add photos, titles, and descriptions, and then share the card. An electronic, human-readable trading card 200 may be a template that sports teams, models, or role playing game companies use to add their images and profiles for sharing or sale. An electronic, human-readable note card 200 may be a template that allows users to share text information. An electronic, human-readable anonymous card 200 may be a template that allows a user to shield his personal information from recipients, but still share certain pieces of information.

With reference again to FIG. 1, in one embodiment of the invention, a user of the originating device 104 accesses the service provider's server 112 over the network 120 in order to, for example, create, edit, search, and view electronic, human-readable cards 200. For example, the originating device 104 may be a desktop computer and the user may access the service provider 112 through a portal. In one exemplary embodiment, the user has a “home page” on the service provider's server 112 that is accessible only by the user. For example, the home page may be password protected. The home page may display links to recently created and/or accessed cards 200 and/or to favorite cards 200. Links to enable the user to edit existing cards 200, to create new cards 200, and to search and view publicly available cards 200 may be provided. Advertisements targeted to the user, for example based on the user's profile, the user's card inventory (and information therein), and/or preferences, may also appear on the home page. The user may have the ability to select a particular card 200, view metadata associated with the card 200, and use the card 200 as a template for the creation of a new card 200 with new information. The user's cards 200 and/or a public directory of cards 200 may also be filterable and/or searchable by a keyword, for example in the form of a tag cloud.

In one embodiment, to create a new electronic, human-readable card 200, the user inputs data via the home page. The data may include any of the graphical information 204, personal information 208, or advertising information 212 described above. Optionally, the home page may provide the user with the ability to import the personal information 208 from social networking sites or email accounts. The user may also select preferences describing how the data is to be displayed in the card 200. Those preferences may include, for example, a choice of the template styles described above, background color, and fonts. The user may also specify preferences for the layout and content of the interface for other cards 216, the processing options interface 220, and/or the membership interface 224. Alternatively, the layout and content of the interfaces 216, 220, and 224 may be determined by the service provider's server 212 by default.

The user may also input digital rights to be associated with the sharing of the card 200. The digital rights assigned by the user may be used throughout the lifecycle of the shared card 200. Exemplary digital rights include single views of the shared card 200, time-period based access to the shared card 200, perpetual access to the shared card 200, and revocation of all previous rights.

Unique digital rights that may be assigned include a designation of update rights or rights relating to the refresh of data. For example, the digital rights may include: i) no refresh requests, such that recipients receive the original card 200 and cannot request an update from the owner/creator of the card 200; ii) refresh requests allowed, such that recipients receive the original card 200 and have a mechanism, for example embedded in the card 200, to request an update from the owner/creator of the card 200; and iii) automatic refresh requests, such that recipients receive the original card 200 and embedded in the card 200 is a mechanism to automatically request updates when viewed by the recipient.

In one embodiment, these data, preferences, and digital rights are stored in storage 144 by the service provider's server 112. The service provider's server 112 may also store in storage 144 metadata about the data entered by the user. Such metadata may relate to contact points (i.e., addressable addresses for messaging a human), media types, media sizes, the intended purpose of content, and/or any other information transferred to the service provider's server 112 through the input process either explicitly by the user or implicitly by the process itself. Examples of contact points include fax numbers, email addresses, phone numbers, mobile phone numbers, mailing addresses, social network IDs, and instant messaging IDs. In one embodiment, the data, preferences, and digital rights entered or selected by the user are precompiled to create the electronic, human-readable card 200 and the card 200 is itself stored in the storage 144. Several displayable versions of the human-readable card 200 may be prepared and stored based on the user's preferences. These versions of the human-readable card 200 may display the data entered by the user in various combinations of, for example, text, HTML, and/or graphics, and may be optimized and sized for display on different mobile devices or Internet web pages. In one embodiment, the storage 144 stores versions of the human-readable card 200 ready for delivery to, and optimized for readability on, at least approximately 80% of targeted displays. Different mobile displays may account for the majority of the targets. Alternatively, in another embodiment, the raw data, preferences, and digital rights entered or selected by the user are stored in storage 144, such that the card 200 may be dynamically created at a later time.

In one embodiment, the user has the ability to make one or more of his cards 200 available for viewing by others by marking the cards 200 as “public.” For example, while creating or editing a card 200, the user may choose to mark the card 200 as public. The service provider's server 112 may then publish the card 200 in a publicly accessible and searchable directory of cards 200, and/or make the card 200 available to be found by Internet search engines.

The home page, or a page linked to and accessible from the home page, may provide the user with several options related to the viewing and sharing of the electronic, human-readable cards 200. For example, the user's home page may have an inbox that includes messages from other users. Those messages may contain, or provide access to, cards 200 shared by those other users. The user may also define keywords, for example short text strings, that correspond to particular ones of his cards 200. These keywords may facilitate the easy sharing of cards from, for example, a mobile handheld computing device by utilizing SMS. The user may also have the ability to alter the properties of his home page, including a username and password associated therewith.

In one embodiment, the user's home page provides the user with information relating to his account, the user's contacts, and cards 200 sent, received, accepted, and/or denied. In addition, the user may identify and select another user (i.e., a contact) or group of users to whom information is to be sent in the form of cards 200. A contact list may display, for each contact, a name or other identifier, an e-mail address, and/or a phone number, or any other information relating to that particular contact.

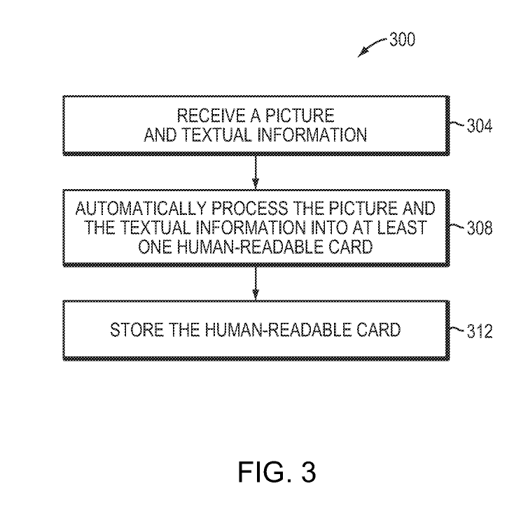

With reference now to FIG. 3, one embodiment of a method 300 for creating an electronic, human-readable card 200 for dissemination over a computer network 120 is depicted. As will be described, the method 300 may be implemented without the user accessing his home page at the service provider's server 112. Using the system 100 depicted in FIG. 1 as an exemplary system to describe the method 300, a picture and textual information are received at the service provider's server 112 at step 304, and the picture and textual information are automatically processed at the server 112, at step 308, into at least one human-readable card 200. Optionally, at step 312, the electronic human-readable card 200 may also be stored at the server 112.

In greater detail, at step 304, a picture and textual information may be received by the receiver 124 of the service provider's server 112. For example, using an originating device 104 that is a mobile handheld computing device equipped with a camera, a user may take a picture. The user may then send the picture to the service provider's server 112 in, for example, the form of an email or MMS message. The user may also send textual information to the server 112 by filling in the “Subject” or “Note” fields of the e-mail or MMS message. The textual information may be, for example, a keyword identifying the type of template the user would like for his card 200, information to be included in the personal information 208 of the card 200, a keyword identifying the type of advertising information 212 the user would like his card 200 to contain, a keyword identifying the user's desired content and layout of the interfaces 216, 220, and 224 of the card 200, or any other type of textual information relevant to the creation of the card 200. In one embodiment, upon receipt of the picture and textual information, the service provider's server 112 resolves the identity of the sender, for example from the “From” field in the e-mail or MMS message. The service provider's server 112 may also determine whether the sender has an account with the service provider (i.e., is an existing member), for example by comparing the sender's identity to a list of account holders. If the sender is not an existing member, the service provider may transmit to the sender (i.e., the user of the originating device 104) a temporary user identification code and a temporary password.

At step 308, the processing module 140 of the service provider's server 112 automatically processes the picture and the textual information into at least one human-readable card 200. For example, the picture may be stored as graphical information 204 in the card 200, and the received textual information may be included as personal information 208 in the card 200 or be used to select the appropriate content and layout for the advertising information 212 and/or interfaces 216, 220, 224 of the card 200. In one embodiment, the picture and textual information are automatically processed by the processing module 140 into a plurality of human-readable cards 200. For example, as earlier described, several displayable versions of the human-readable card 200 may be prepared. Each one of those displayable versions may be optimized and sized for presentation, in substantially its entirety, on a display of different mobile handheld computing devices.

At step 312, the processing module 140 of the service provider's server 112 may store the newly-created electronic, human-readable card 200 in the storage 144 for future use. Optionally, the card 200 may also be sent back to the originating device 104 for review by its creator.

The user of the originating device 104 may then share the newly-created card 200 over the computer network 120 with any desired number of recipients using, for example, the method 400 described below. As described with reference to the method 400, as the card 200 may be shared with multiple recipients using SMS or another text-based communication protocol, the sharing of the card 200 among the multiple recipients may be made far less expensive and more convenient for the user of the originating device 104 than if he were to send the picture via MMS, especially if the user desires to share the card 200 with a large number of recipients.

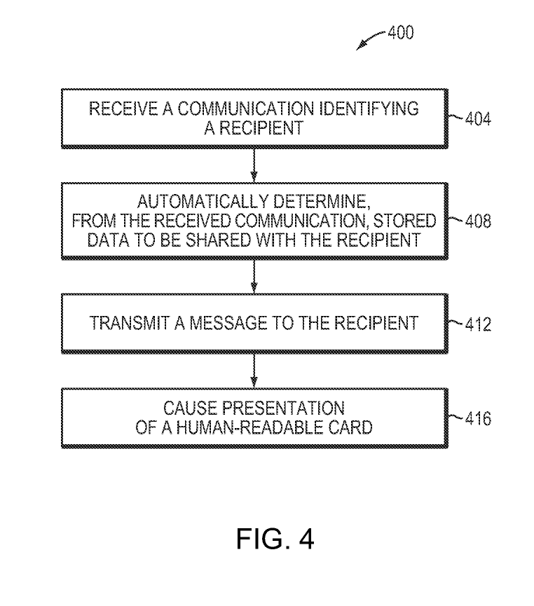

With reference now to FIG. 4, in one embodiment of a method 400 for sharing data, using, for example, the exemplary system 100 depicted in FIG. 1, a communication identifying a recipient is received at the service provider's server 112 at step 404, stored data to be shared with the recipient is automatically determined from the received communication by the server 112 at step 408, and presentation of a human readable card 200 is caused at step 416. Optionally, the method 400 may also include, prior to causing presentation of the human-readable card 200 at step 416, transmitting a message from the server 112 to the recipient (at step 412).

In greater detail, at step 404, the receiver 124 of the service provider's server 112 receives, over the network 120, a communication identifying a recipient. The communication may be received from the originating device 104, which may be, for example, a mobile handheld computing device. In one such embodiment, the communication received from the mobile handheld computing is a text-based message, such as an SMS message, an e-mail message, or an instant message. In one particular embodiment, the content of the received communication consists solely of text. Alternatively, the originating device 104 may be a desktop computing device or other type of computing device, and the communication may be received therefrom. In such a case, the received communication may again be a text-based message, such as an e-mail message or an instant message.

The text-based communication created by the user of the originating device 104 and sent to the receiver 124 of the service provider's server 112 may be relatively simple. For example, in one embodiment, the content of the communication includes or consists solely of a first identification for a destination of the communication, a second identification for the user of the originating device 104, and a third identification for the recipient. For example, a user of the originating device 104 may create an SMS or e-mail message having a “To” field that specifies an address for the service provider's server 112 (e.g., the server 112 may be addressable by a 10-didgit telephone number or an e-mail address), a “From” field that is automatically filled in with an address for the user of the originating device 104 (e.g., a 10-didgit telephone number or an e-mail address), and a body that specifies an address for the recipient device 116 (e.g., a 10-didgit telephone number, an e-mail address, or a keyword from a naming scheme previously stored by the originating user at the server 112 that identifies the recipient device 116).

In one embodiment, the user of the originating device 104 also includes in the communication sent to the service provider's server 112 an accessibility profile, which is a generalized digital rights profile assigned to specific recipient(s), to groups of recipient(s), and/or to specific shared data. The accessibility profile may, for example, specify the data stored in the storage 144 of the server 112 that is (or is not) to be shared with the recipient device 116. The accessibility profile may also include an assignment of digital rights from the user of the originating device 104 as to the how the data being shared may be viewed and/or further distributed by the recipient device 116. Accessibility profiles may be embodied by a set of rules that define access rights, which may be constructed from the categorization of information, user's roles, and/or relationships. For example, a user may define an accessibility profile to grant viewing rights to cards 200 containing his family photos to contacts in his circle identified as family, while also denying viewing rights to the same or other photos to a specific contact not categorized as family. The accessibility profile may also deny or allow editing rights to all content created by the specified user. Optionally, the accessibility profile may include a cascading digital rights infrastructure for the shared data as well as the atomic elements included in the shared data. Each user of an originating device 104 may have multiple accessibility profiles.

In one embodiment, the accessibility profile specifies, for example, the particular human-readable cards 200 earlier created by the user of the originating device 104 and now stored in the storage 144 that are to be shared with the recipient device 116. As another example, the accessibility profile may specify that stored data divulging an identity of the user of the originating device 104 is not to be shared with the recipient device 116. In such an embodiment, the service provider's server 112, as explained below with reference to steps 408, 412, and 416 of the method 400, does not send a card 200 having personal information 208 identifying the user of the device 104, but rather a card 200 indicated to have an “anonymous template.”

In one particular embodiment of the invention, the content of the communication sent by the originating device 104 and received by the receiver 124 of the service provider's server 112 consists solely of the first identification for a destination of the communication (e.g., an address for the server 112), the second identification for the user of the originating device 104 (e.g., an address for the originating device 104), the third identification for the recipient device 116 (e.g., an address for the recipient device 116), and the accessibility profile specifying the stored data to be shared with the recipient.

In one embodiment, keywords earlier created by the user of the originating device 104 and stored in his account at the service provider's server 112 may be used to implement the accessibility profiles. For example, the user may type the keyword “anonymous” in the body of his text-based communication to the service provider 112 to indicate that he wishes to share the card 200 having the “anonymous template” with the recipient device 116. As another example, the user of the device 104 may employ descriptive keywords to identify particular cards 200 to be shared with the recipient device 116. For example, the body of the communication may include the keyword “business” where the user wishes to share his business card 200, or the keyword “dog” where the user wishes to share a card 200 having a picture 204 of his pet dog and textual information concerning that dog. Alternatively, where the user has a relatively few number of cards stored in storage 144 at the service provider's server 112, the user may have key-numbers associated with his cards. For example, typing the number 3 in the body of the text-based communication may result in card #3 being shared with the recipient device 116.

In another embodiment, a keyword included in the communication from the user of the originating device 104 may identify both a recipient device 116 (or group of recipient devices 116) and the particular card(s) 200 that are to be shared with the recipient device(s) 116.

In still another embodiment, the communication sent by the originating device 104 to the service provider's server 112 may include information concerning the display of the recipient computing device 116 (e.g., a choice of preferred style for the card 200 and a default display device). Where a user of the recipient device 116 is registered with the service provider 112, he may have previously provided to the service provider's server 112 information concerning the display of his device 116. In such a case, the information concerning the display of the recipient computing device 116 may be determined by matching the identifier for the recipient in the body of the text-based communication received from the originating device 104 with the information previously provided by the recipient. In another embodiment, the information concerning the display of the recipient computing device 116 may be known by the user of the originating device 104 and provided to the service provider's server 112 in the communication sent by the user of the originating device 104, for example through a keyword or other identifier. In still another embodiment, if the recipient is not a registered user of the service provider, a link, as described further below, for accessing a card 200 may be sent to the recipient device 116. The appropriate card 200 may then be shared with the recipient device 116 based on the type of device 116 from which the link is accessed. This is described further below with respect to step 416 of the method 400.

In yet another embodiment, the communication received at the server 112 originates from the selection, by the user of the originating device 104, of a graphic or widget on an Internet web page. For example, the originating device 104 may be viewing a web page hosted by the third party server 108. Content on the web page corresponding to information stored in a human-readable card 200 in the storage 144 of the service provider's server 112 may be indicated by the use of an embedded identifier, such as a graphic or widget on the web page. To send the content to a recipient device 116 in the form of the human-readable card 200, the user of the originating device 104 may select the identifier. In doing so, the user of the originating device 104 may be prompted to enter information identifying himself and/or the recipient device 116 (e.g., 10-digit telephone numbers or e-mail addresses). The third party server 108 may then send a communication having the information identifying the originating device 104 and/or recipient device 116, along with information identifying the third party server 108, to the service provider's server 112. In selecting the identifier, the user of the originating device 104 may also be presented with a view of the human-readable card 200 that will be presented, as described below, to the recipient device 116. In addition, if the user of the originating device 104 does not have an account with the service provider (i.e., is not a member, which may be determined, for example, by the information the user of the originating device 104 provided to identify himself), the user may also be prompted to open an account with the service provider.

At step 408, the determination module 128 of the service provider's server 112 automatically determines, from the communication received by the receiver 124 at step 404, the data stored in the storage 144 that is to be shared with the recipient device 116. As an initial matter, the information contained in the received communication that identifies the user of the originating device 104, or that identifies the third party server 108, may be used by the determination module 128 to narrow the universe of cards stored in storage 144 (i.e., the determination module 128 may employ that information to focus on those cards belonging to the user of the originating device 104 or to the owner of the third party server 108). Then, where the accessibility profile specifies the electronic, human-readable card 200 to be shared with the recipient device 116, the determination module 128 may create a link to that card 200. Alternatively, where the received communication does not contain an accessibility profile specifying the stored data to be shared with the recipient device 116, the determination module 128 may create a link to a default card 200. In addition, where multiple versions of the same card 200 exist, the determination module 128 may create a link to the stored version of the card 200 most appropriate for presentation on a display of the recipient computing device 116.

In one embodiment, where the card 200 is being shared with multiple recipients, the determination module 128 creates a unique link to the card 200 for each recipient. Doing so may enable the user of the originating device 104 to control each recipient's access to the card 200 in a different manner. For example, links for certain recipients may be revoked, while links for other recipients may be maintained.

In another embodiment, if the card 200 to be shared with the recipient device 116 includes textual information in a font not available for display on the recipient device 116, the processing module 140 may render the information utilizing the font as a graphic rather than as text such that the preferred font may be presented to the recipient device 116. In still another embodiment, if none of the stored versions of the cards 200 are appropriate for display on the recipient device 116, the processing module 140 has the ability to render an appropriate version of the card “on the fly” for sharing with the recipient device 116. In addition, as previously mentioned, rather than storing human-readable cards 200 in the storage 144 of the server 112, raw data, preferences, and digital rights previously entered or selected by the user of the originating device 104 may be stored in storage 144, such that the card 200 is dynamically created by the processing module 140 upon receipt of the communication from the originating device 104.

Following the determination, at step 408, of the stored data that is to be shared with the recipient device 116, the transmitter 136 of the service provider's server 112 may transmit, at step 412, a message to the recipient device 116. The transmitted message may be a text-based message, such as an SMS message, an e-mail message, or an instant message, and may include the link to the electronic, human-readable card 200.

Finally, at step 416, the presentation module 132 of the service provider's server 112 may cause presentation of the human-readable card 200 to the recipient device 116. For example, when a user of the recipient device 116 accesses the link transmitted thereto, a web browser application on the recipient device 116 (for example a mobile web browser on a mobile handheld computing device 116) may be launched, and the presentation module 132 may cause the human-readable card 200 previously determined by the determination module 128 to be the appropriate card for the recipient device 116 to be presented at the recipient device 116. Alternatively, in another embodiment, when the recipient device 116 accesses the link, the presentation module 132 may perform detection on a combination of the UserAgent, capabilities, and network found in the HTTP Request originating from the recipient device 116 application (typically a web browser) in order to determine the appropriate card 200 to share. From the detection process, the presentation module 132 may define the type of display employed by the recipient device 116 and may then share the appropriate card 200 with the recipient device 116. Accordingly, the appearance of the card 200 when it is eventually presented to the recipient device 116 may depend on input from both a user of the originating device 104 and the recipient device 116.

In one embodiment, after being presented with the card 200, a user of the recipient device 116 may request that the card 200 be rendered into a raster image and that the raster image be transmitted to the recipient device 116 for storage thereat. For example, the processing options interface 220 of the card 200 may present to the user an option to rasterize and locally save the card 200. In one embodiment, in response to a request from the recipient device 116, the presentation module 132 rasterizes the card 200 based on the display capabilities of the recipient device 116 and the importance of the data fields associated with the card 200. For example, each data field may be ranked ahead of time to determine how it will be treated and laid out so that the card 200 will be legible on the given recipient device 116 having the particular display capabilities. In one embodiment, the presentation module 132 also verifies the rasterized card 200 with an optical character recognition process to ensure legibility of the rasterized card 200. Once appropriately rasterized, the transmitter 136 may send the rasterized card 200 to the recipient device 116.

The rasterized card 200 may also be encoded with a code that may later be decoded. For example, the recipient device 116 may later send its stored version of the rasterized card 200 to the service provider's server 112. The code may then be decoded by the service provider's server 112 to look up remaining data associated with the card 200. The service provider's server 112 may also be able to interpret the card 200 from the code, and take appropriate measures based on information associated with the card 200.

In another embodiment, rather than transmitting a link to the recipient device 116 at step 412 and then causing presentation of the stored card 200 to the recipient device 116 at step 416 when the recipient device 116 accesses the link, the card 200 may be retrieved from storage 144 and itself transmitted by the transmitter 136 to the recipient device 116. In one such embodiment, the recipient device 116 includes a presentation module having a functionality similar to the presentation module 132 of the service provider's server 112 described above, so that the human-readable card 200 may be presented to the user of the recipient device 116. For example, the transmitter 136 may transmit the card 200 to the recipient device 116 in an e-mail message. In such a case, one or more attachments (e.g., other data associated with the card 200, such as additional documents or graphics) may be transmitted together with the card 200.

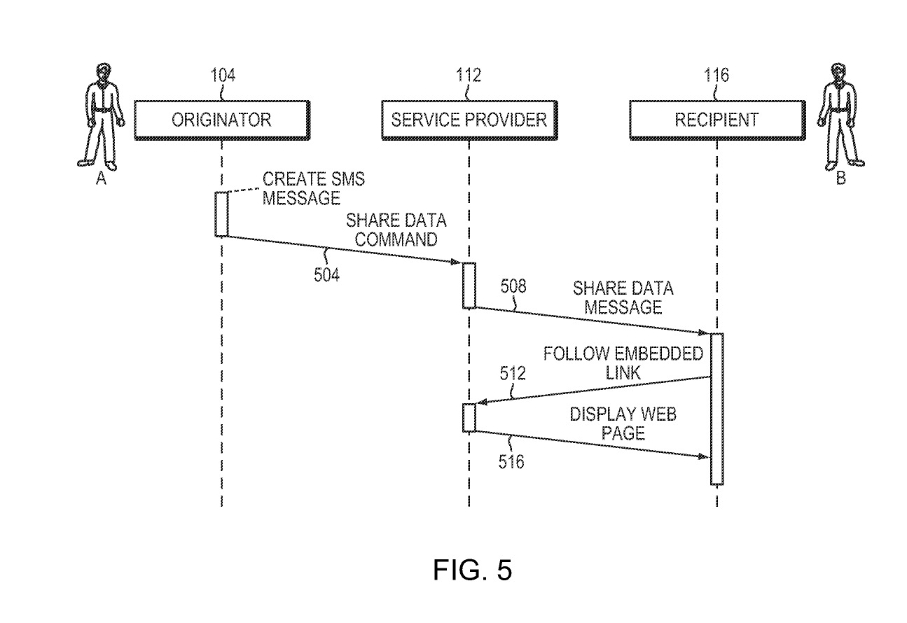

FIGS. 5-8 depict several non-limiting examples for sharing the human-readable cards 200 described above, using the methods described above. With reference first to FIG. 5, in one embodiment, an originating device 104 shares a card 200 with a recipient device 116 by using SMS and default settings provided at the service provider's server 112. The use of SMS is, however, exemplary, and any suitable text-based protocol may be used. The user of the originating device 104 first creates a message on the originating user's handheld mobile computing device 104. In one embodiment, the message includes two items of information: i) the destination, which references the service provider's server 112; and ii) the body of the SMS, which identifies the recipient. The user may create the message using an SMS client application or a card-based client application (i.e., a specific application installed on the user's mobile handheld computing device 104 that allows the user to interact with the electronic, human-readable cards 200 described above). When using the SMS client application, the user begins by creating a new message and then is presented with multiple fields to fill out, for example the “To,” “Subject,” and “Message” fields, although only the “To” and “Message” fields may be filled out, as previously described. When using the card-based client application, the user may select a command for sharing cards 200 (e.g., a “Share” command). The “Share” command may generate a message that will authorize and command the service provider's server 112 to send one or more of the user's cards 200 to a referenced recipient device 116. The user may enter a recipient identifier by filling in a text field or by selecting from a list of contacts configured in the application. The recipient identifier may also be found by utilizing a “Find” function provided in the card-based application, which may query an external service (e.g., a directory service). A user of the originating device 104 may then send a message (step 504) from the originating user's application by selecting a “Send” function. An identifier for the user of the originating device 104 may be automatically added by the device 104.

In one embodiment, the service provider's server 112 receives the SMS message from the originating device 104 and looks up account information for the user of the originating device 104 based on the source identifier found in the message. The source identifier may be extracted from the SMS message by selecting the “From” field in the SMS message and then performing a lookup in a service provider directory service, thereby resulting in the source identifier for referencing the originating user. The source identifier and a mobile phone number may be paired in the service directory when an account is created in the service provider's server 112 or when a user manages his mobile phone numbers with the service provider's server 112 through a web portal, a mobile portal, the card-based client application, or any other access point tied to the service provider's server 112. The service provider's server 112 may then verify the identity of the originating user and that the recipient device 116 is reachable.

If a card 200 is allowed to be shared with the recipient device 116 based on, for example, applicable accessibility profiles that were previously prepared by the originating user, stored at the service provider's server 112, and apply to the recipient device 116, then the service provider's server 112 may generate, for SMS message delivery, a condensed message summary that indicates the purpose of the message and a reason for the recipient to select a link embedded in the message. The SMS message may then be sent to the recipient device 116 (step 508).

The recipient device 116 may then immediately access the data in the SMS message and follow the embedded link (step 512) to a mobile Internet page that displays (step 516) the card 200 shared by the user of the originating device 104. In one embodiment, a user of the recipient device 116 selects the link in the SMS message from the SMS client application. In another embodiment, the link is selected automatically by a card-based application installed on the recipient device 116. In still another embodiment, the recipient may use his mobile browser to go to the service provider's web portal to pick up his message and follow the link. In one embodiment, the embedded link contains a unique reference to the share action that occurred between the originating device 104 and the recipient device 116, which embodies the data and accessibility profile of that share. In some cases, the link may not reference a specific URL, but rather a time-sensitive transaction that is valid only on the recipient device 116 that received it. The link may also include a reference to the service provider's storage 144 such that the data may be received via HTTP.

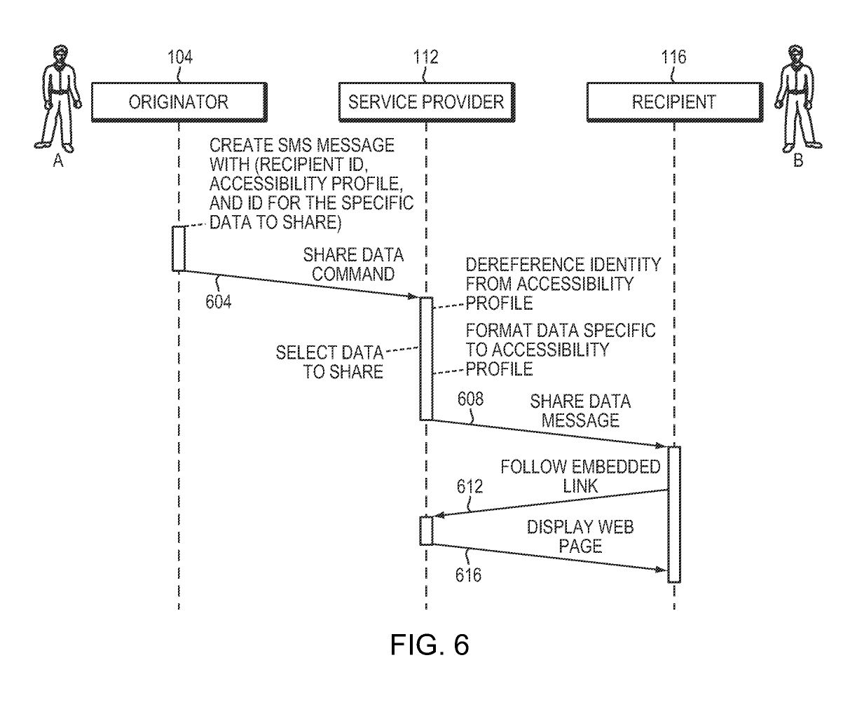

Referring now to FIG. 6, in another exemplary implementation of the systems and methods described herein, an originating device 104 shares one or more electronic, human-readable cards 200 with a recipient device 116 by specifying, in an SMS message, a source identity, the destination for the SMS message, the recipient, specific data (e.g., cards 200) for sharing with the recipient device 116, and an accessibility profile to be applied to the specific data for sharing. Again, the use of SMS is exemplary, and any suitable text-based protocol may be used.

The user of the originating device 104 may first create the SMS message on his mobile handheld computing device 104. The SMS message may include the destination, which references the service provider's server 112, and a body, which may include an identifier for the recipient device, the specific data for sharing, and the accessibility profile. The address for the service provider's server 112 may be the first piece of information included in the SMS message and may identify the service provider's server 112 by any usable address available on the network 120, for example a mobile phone number, an e-mail address, or a short code.

In one embodiment, the user of the originating mobile handheld computing device 104 sends (step 604) the SMS message from a SMS client application on the device 104 or from a card-based client application that can send SMS messages from the device 104. For the card-based client application, sending the SMS message may be automated and independent from creation of the message.

In one embodiment, the service provider's server 112 receives the SMS message from the originating device 104, and looks up data for the user of the originating device 104 based on the source identity found in the message. The user's specific data identified for sharing may be retrieved from the storage 144. Again, the source identifier may be extracted from the SMS message by selecting the “From” field in the SMS message and then performing a lookup in a service provider directory, which results in the source identifier referencing the user of the originating device 104.

The service provider's server 112 may verify the identity of the originating user by correlating a mobile number extracted from the “From” field of the SMS message with the data specified for sharing. The service provider's server 112 may also verify that the recipient device 104 is reachable and that the assigned accessibility profile allows for viewing of the specified card 200. In one embodiment, the accessibility profile is applied to the data specified for sharing to determine the actual data that may be shared with the recipient device 116. In one embodiment, if there is no information remaining after the accessibility profile has been applied, then no message is sent to the recipient device 116.

If there is data (e.g., card(s) 200) that is allowed to be shared with the recipient device 116, then the service provider's server 112 may generate and transmit (step 608) to the recipient device 116 an SMS message that includes a link the card(s) 200. The recipient may then access the data in the SMS message and follow the embedded link (step 612) to a mobile Internet page that displays (step 616) the card(s) 200.

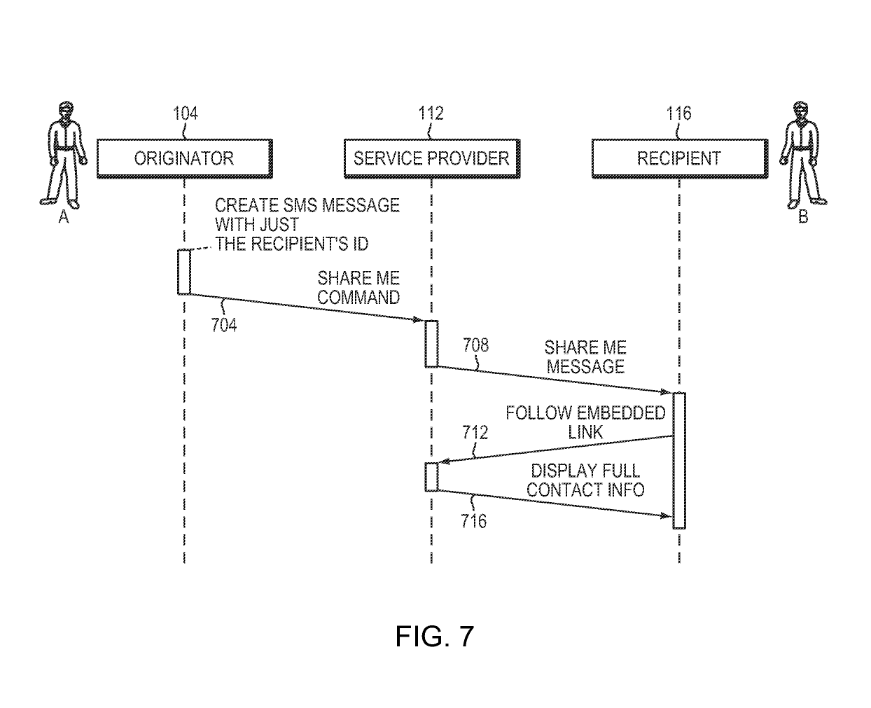

Referring now to FIG. 7, in another exemplary implementation, a user of the originating device 104 shares his contact information in the form of a human-readable card 200 (e.g., a business card) with a recipient. In one embodiment, the originating user creates an SMS message on his mobile handheld computing device 104. The message includes a destination, which references the service provider's server 112, and the body of the SMS message, which identifies the recipient. The user of the originating device 104 sends the SMS message to the service provider's server 112 (step 704). In one embodiment, the service provider's server 112 receives the SMS message from the user of the originating device 112 and determines, based on the source identifier found in the SMS message, a card 200 having contact information for that user (e.g., a business card 200). For example, that card 200 may be a default card 200 to be selected by the service provider's server 112 when the SMS message received from the user does not specify a specific card 200 to be shared by the user. The service provider's server 112 may then verify the identity of the originating user and that the recipient device 116 is reachable. The service provider's server 112 may then generate an SMS message having a link to the card 200 embedded therein and transmit the SMS message to the recipient device 116 (step 708). As before, a user of the recipient device may access the link (step 712) to view the card 200 (step 716).

In one embodiment, each user of an originating device 104 is responsible for entering his own contact information into the service provider's server 112. In various ways, this is an improvement from other methods of sharing contact information. For example, after the data is entered, the users of the originating devices 104 are simply tasked with addressing each individual with whom they want to share their contact information. No further data entry is needed. Moreover, the contact information is continuously available from a central service provider. Local copies of the contact information need not be stored. In addition still, as discussed above, the card 200 storing the contact information may be a live card. In such a fashion, modification to a user's contact information does not cause an unnecessary communication of that information to all registered users. Rather, each time that a user accesses a link to the card 200 having the contact information, he may be provided with the most-recent contact information. Thus, unlike a VCARD, for example, which provides a one way delivery without the ability for an update, the cards 200 described herein allow for periodic updates.

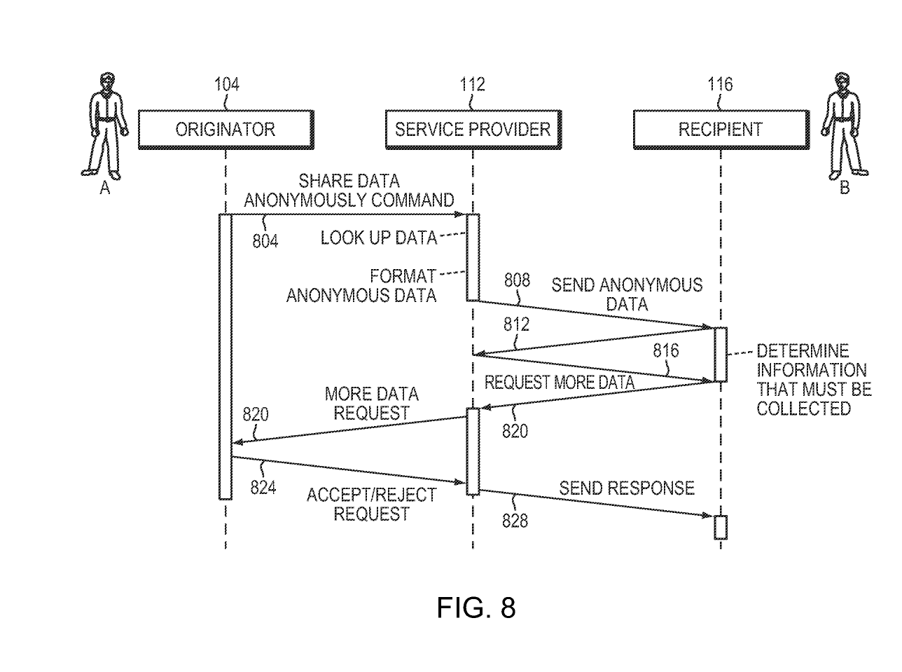

With reference now to FIG. 8, in yet another exemplary implementation, a user of an originating device 104 may share with a recipient device 116 a card 200 having only anonymous information. This enables, for example, users of originating devices 104 to respond to surveys and questionnaires by providing an anonymous card 200 lacking any personal information 208. In this example, the recipient device 116 may in fact be a software agent registered with the service provider 112.

In one embodiment, a user of the originating device 104 creates an SMS message on a mobile handheld computing device 104. The SMS message may include a destination, which references the service provider's server 112, and a body that includes an identifier of the recipient device 116 and an anonymous accessibility profile. The anonymous accessibility profile may specify the specific data (e.g., the user's “anonymous” card 200) for sharing with the recipient device 116. In one embodiment, the user of the originating device 104 transmits the SMS message to the service provider's server 112 (step 804). The service provider's server 112 may then receive the SMS message and determine the specific data for the user of the originating device 104 based on the source identifier found in the SMS message. Again, the service provider's server 112 may verify the identity of the originating user and that the recipient device is reachable. By applying the anonymous accessibility profile to the user's data stored in the storage 144 at the service provider's server 112, the server 112 is able to identify the “anonymous” card 200 of the user for sharing with the recipient device 116.

The service provider 112 may then generate an SMS message that includes a link to the “anonymous” card 200, and send the SMS message to the recipient device 116 (step 808). In one embodiment, the identity of the user at the originating device 104 is hidden from the recipient device 116 at all times. The recipient device 116 may then access the link in the SMS message and follow it (step 812) to a mobile Internet page that displays the “anonymous” card 200 (step 816). Optionally, the “anonymous” card may be provided to the recipient device 116 in another form, for example XML, so that it is suitable for incorporation into the recipient's data system.

In some embodiments, rather than including an anonymous accessibility profile in the SMS message sent from the originating device 104 to the service provider's server 112, a separate service provider may be used for all anonymous communication.

In some embodiments, the “anonymous” card 200 shared with the recipient device 116 includes a link to a web page that allows the recipient device 116 to request specific information. If the recipient device 116 requests specific information (step 820), a user of the originating device 116 may accept or deny the request (step 824), and the user's response to the request (e.g., denial, or acceptance with requested information) may be transmitted to the recipient device 116 (step 828). As described, this model allows for the negotiation of information to be shared with the recipient device 116 on the terms of the user of the originating device 104.

Accordingly, in addition to other advantages, embodiments of the present invention allow various forms of data, such as human-readable cards 200 having a variety of content (such as textual, graphical, and other content) to be shared in a convenient and efficient manner. More specifically, as described herein, simple text-based messages may be employed to share the cards 200, which themselves may contain more complex content (such as graphics).

It should be noted that embodiments of the present invention may be provided as one or more computer-readable programs embodied on or in one or more articles of manufacture. The article of manufacture may be a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for sharing stored data, comprising:
receiving, from a first computing device, a communication identifying a recipient;
automatically determining, from the received communication, stored data to be shared with the recipient; and
causing presentation of a human-readable card, comprising both textual and graphical information, in substantially its entirety on a display of a mobile handheld computing device employed by the recipient, thereby sharing the stored data with the recipient.

2. The method of claim 1, wherein the communication is a text-based message.

3. The method of claim 2, wherein the text-based message is selected from the group consisting of an SMS message, an e-mail message, and an instant message.

4. The method of claim 1, wherein the communication consists of text.

5. The method of claim 1, wherein the communication originates from the selection, by a user of the first computing device, of a graphic on an Internet web page.

6. The method of claim 1, wherein the communication is received over a network from a mobile handheld computing device.

7. The method of claim 1, wherein the communication is received over a network from a desktop computing device.

8. The method of claim 1, wherein the communication further comprises an accessibility profile specifying the stored data to be shared with the recipient.

9. The method of claim 8, wherein the accessibility profile specifies that stored data divulging an identity of a user of the first computing device is not to be shared with the recipient.

10. The method of claim 1, wherein the communication consists of a first identification for a destination of the communication, a second identification for a user of the first computing device, and a third identification for the recipient.

11. The method of claim 1, wherein the communication consists of a first identification for a destination of the communication, a second identification for a user of the first computing device, a third identification for the recipient, and an accessibility profile specifying the stored data to be shared with the recipient.

12. The method of claim 1, wherein automatically determining the stored data to be shared with the recipient comprises creating a link to a stored version of a human-readable card appropriate for presentation on the display of the mobile handheld computing device employed by the recipient.

13. The method of claim 12, wherein the communication further comprises information concerning the display of the mobile handheld computing device employed by the recipient.

14. The method of claim 1, wherein the stored data comprises data personal to a user of the first computing device.

15. The method of claim 14, wherein the stored data personal to the user is at least one of contact information for the user, biographic information of the user, information concerning interests of the user, information concerning activities related to the user, health information for the user, account information for the user, or business information for the user.

16. The method of claim 1, wherein the stored data comprises advertising information.

17. The method of claim 1, wherein at least a portion of the human-readable card represents an RSS feed.

18. The method of claim 1, wherein the human-readable card is a live card configured to be updated with new data.

19. The method of claim 1, wherein the mobile handheld computing device comprises a mobile phone.

20. The method of claim 1 further comprising transmitting a message to the recipient prior to causing presentation of the human-readable card to the recipient, the transmitted message comprising a link to the human-readable card.

21. The method of claim 20, wherein the transmitted message is a text-based message.

22. The method of claim 21, wherein the transmitted message is selected from the group consisting of an SMS message, an e-mail message, and an instant-message.

23. A system for sharing stored data, comprising:
a receiver for receiving, from a first computing device, a communication identifying a recipient;
a determination module for automatically determining, from the received communication, stored data to be shared with the recipient; and
a presentation module for causing presentation of a human-readable card, comprising both textual and graphical information, in substantially its entirety on a display of a mobile handheld computing device employed by the recipient to thereby share the stored data with the recipient.

24. The system of claim 23, wherein the communication is a text-based message.

25. The system of claim 24, wherein the text-based message is selected from the group consisting of an SMS message, an e-mail message, and an instant message.

26. The system of claim 23, wherein the communication consists of text.

27. The system of claim 23, wherein the communication originates from the selection, by a user of the first computing device, of a graphic on an Internet web page.

28. The system of claim 23, wherein the receiver is configured to receive the communication over a network from a mobile handheld computing device.

29. The system of claim 23, wherein the receiver is configured to receive the communication over a network from a desktop computing device.

30. The system of claim 23, wherein the communication further comprises an accessibility profile specifying the stored data to be shared with the recipient.

31. The system of claim 30, wherein the accessibility profile specifies that stored data divulging an identity of a user of the first computing device is not to be shared with the recipient.

32. The system of claim 23, wherein the communication consists of a first identification for a destination of the communication, a second identification for a user of the first computing device, and a third identification for the recipient.

33. The system of claim 23, wherein the communication consists of a first identification for a destination of the communication, a second identification for a user of the first computing device, a third identification for the recipient, and an accessibility profile specifying the stored data to be shared with the recipient.

34. The system of claim 23, wherein the determination module is configured to create a link to a stored version of a human-readable card appropriate for presentation on the display of the mobile handheld computing device employed by the recipient.

35. The system of claim 34, wherein the communication further comprises information concerning the display of the mobile handheld computing device employed by the recipient.

36. The system of claim 23, wherein the stored data comprises data personal to a user of the first computing device.

37. The system of claim 36, wherein the stored data personal to the user is at least one of contact information for the user, biographic information of the user, information concerning interests of the user, information concerning activities related to the user, health information for the user, account information for the user, or business information for the user.

38. The system of claim 23, wherein the stored data comprises advertising information.

39. The system of claim 23, wherein at least a portion of the human-readable card represents an RSS feed.

40. The system of claim 23, wherein the human-readable card is a live card configured to be updated with new data.

41. The system of claim 23, wherein the mobile handheld computing device comprises a mobile phone.

42. The system of claim 23 further comprising a transmitter for transmitting a message to the recipient prior to causing presentation of the human-readable card to the recipient, the transmitted message comprising a link to the human-readable card.

43. The system of claim 42, wherein the transmitted message is a text-based message.

44. The system of claim 43, wherein the transmitted message is selected from the group consisting of an SMS message, an e-mail message, and an instant-message.

45. A method for creating a human-readable card for dissemination over a computer network, the method comprising:
receiving, at a server, a picture and textual information; and
automatically processing, at the server, the picture and the textual information into at least one human-readable card configured for i) dissemination over a computer network and ii) presentation in substantially its entirety on a display of a mobile handheld computing device.

46. The method of claim 45 further comprising storing the human-readable card at the server.

47. The method of claim 45, wherein the picture and the textual information are automatically processed into a plurality of human-readable cards, each one of the plurality of human-readable cards being configured for presentation in substantially its entirety on the display of a different mobile handheld computing device.

48. A system for creating a human-readable card for dissemination over a computer network, comprising:
a receiver for receiving a picture and textual information; and
a processing module for automatically processing the picture and the textual information into at least one human-readable card configured for i) dissemination over a computer network and ii) presentation in substantially its entirety on a display of a mobile handheld computing device.

49. The system of claim 48 further comprising storage for storing the human-readable card.

50. The system of claim 48, wherein the processing module is configured to automatically process the picture and the textual information into a plurality of human-readable cards, each one of the plurality of human-readable cards being configured for presentation in substantially its entirety on the display of a different mobile handheld computing device.
